(19) United States
(12) Patent Application Publication
(10) Pub. No.: US 2005/0031806 A1
(43) Pub. Date: Feb. 10, 2005

(54) Composition for an ink acceptable layer of recording medium for inkjet printers and recording medium for using the same

(76) Inventors: Jae-hwan Kim, Suwon-city (KR); Seung-min Ryu, Yongin-city (KR); Taek-yong Jung, Suwon-city (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/774,402

(22) Filed: Feb. 10, 2004

(30) Foreign Application Priority Data
Aug. 9, 2003 (KR) 2003-55233

(51) Int. Cl. B41M 5/00

(52) U.S. Cl. 428/32.38

(57) ABSTRACT

A composition for forming an ink acceptable layer of a recording medium for inkjet printers and a recording medium for inkjet printers using the same. The composition comprises an inorganic filler, hydrophilic binder, core-shell structured cationic latex and polyamide-epichlorohydrin resin, and the recording medium comprises the above-described composition for forming an ink acceptable layer. The composition provides a recording medium for inkjet printers comprising an ink acceptable layer having excellent water and moisture resistance while maintaining a superior ink absorption amount and ink absorption rate.

### CROSS-REFERENCE TO RELATED APPLICATIONS

This application claims the benefit of Korean Patent Application No. 2003-55233 filed Aug. 9, 2003, in the Korean Intellectual Property Office, the disclosure of which is incorporated herein by reference.

### BACKGROUND OF THE INVENTION

1. Field of the Invention

The present invention relates to recording medium, and more particularly, recording medium for inkjet printers with improved water and moisture resistance provided by using a composition for forming an ink acceptable layer that is coated on a surface of a substrate thereof, where the composition comprises ingredients in a certain composition ratio.

2. Description of the Related Art

The printing methods of printers are largely divided into two types: non-impact printing and impact printing. The inkjet printer and printing method is a non-impact printing system and method, and has advantages that include a low noise level, as compared to the impact printing methods, and an ability to readily realize colors, as compared to laser beam printers. Also, the inkjet printers and printing methods are cheap, have a high output speed and produce high-resolution images. Thus, this printing method is widely used.

Printing papers usable for inkjet printers include various recording media such as specially coated inkjet papers and inkjet films, as well as plain papers. If a recording medium for the inkjet printer has a hydrophobic substrate comprising a polyester such as polyethylene terephthalate or cellulose acetate, the hydrophobic substrate is coated with a hydrophilic substance so that an ink can be readily fixed on the recording medium. Here, the coating layer comprising the hydrophilic substance is called an “ink acceptable layer.”

The recording media for inkjet printers comprising a hydrophobic substrate and an ink acceptable layer are applied in the printing of digital photographs or images by thermal type, piezo type or phase-change type inkjet printers, and can be used in numerous applications, such as a presentation means on an Over Head Projector and for outer wall decor, design or advertisement.

In general, recording media are required to preserve a recorded condition for a long period of time without deformation or wear. For recording media for inkjet printers, it is likewise important to preserve a printed condition. Thus, there is a demand for the development of a recording medium for inkjet printers capable of preserving a printed state for a long period of time.

Such improvement attempts are described in U.S. Pat. No. 5,866,268, Japanese Patent Laid-Open No. Sho 55-144,172, and Japanese Patent Laid-Open No. Sho 62-268,682, the entire content of each being incorporated herein by reference, wherein each discloses recording media with ink absorption rate and ink absorption amount values improved by using a hydrophilic resin such as cellulose derivatives, polyvinyl alcohols, and the like, as a binder. However, the inventions disclosed in the foregoing patents have problems of weak water resistance since the hydrophilic resin is easily dissolved in water, causing blurring of the image printed on the recording media.

Still further improvement attempts are described in Japanese Patent Laid-Open No. Sho 59-198,186, and Japanese Patent Laid-Open No. Sho 56-84992, the entire content of each being incorporated herein by reference, wherein each discloses recording media having an ink acceptable layer comprising an organic acid salt of polyethylene amine. According to the these Patents referenced above, the water resistance of the recording media is improved but the thermal resistance and light resistance are deteriorated, thereby undesirable yellowing by ultraviolet light (UV) may occur.

Also, the use of alumina as an inorganic filler in an ink acceptable layer of the recording media has increasingly attracted attention. The alumina has advantages in that it has superior ability to fix a dye in ink as compared to other inorganic fillers, and can produce a high gloss image. Recording media is also noted in U.S. Pat. No. 4,879,166, U.S. Pat. No. 5,104,730, and Japanese Patent Laid-Open No. Hei 2-276,670, Japanese Patent Laid-Open No. Hei 4-37,576 and Japanese Patent Laid-Open No. Hei 5-32,037, the entire content of each being incorporated herein by reference, wherein each discloses recording media comprising an alumina hydrate of a boehmite structure. In addition, Japanese Patent Laid-Open No. Sho 60-67,190, Japanese Patent Laid-Open No. Sho 61-10,584 and Japanese Patent Laid-Open No. Sho 61-57,379, the entire content of each being incorporated herein by reference, each disclose inkjet recording sheets with a cationic polymer and a water soluble polyvalent metal salt added. The recording media according to the inventions disclosed in the foregoing patents show highly improved dye fixation and short-term water resistance but their long-term water resistance is still unsatisfactory. Particularly, in some of the foregoing patents, high temperature moisture resistance is rather deteriorated.

Accordingly, a need exists for a system and method to provide a recording medium for inkjet printers with improved water and moisture resistance provided by using a composition for forming an ink acceptable layer coated on a surface of a substrate.

### SUMMARY OF THE INVENTION

In order to solve the problems as mentioned above, it is an aspect of the present invention to provide a composition for forming an ink acceptable layer of a recording medium for inkjet printers with improved high temperature moisture resistance and long-term water resistance while maintaining an excellent ink absorption rate and ink absorption amount, and a recording medium for inkjet printers comprising the same.

In order to accomplish the above aspect and/or other features of the present invention, a system and method provides a composition for forming an ink acceptable layer of a recording medium for inkjet printers, wherein the composition comprises an inorganic filler, a hydrophilic binder, and a core-shell structured cationic latex and a polyamide-epichlorohydrin resin.

Preferably, in an embodiment of the present invention, the composition for the ink acceptable layer comprises about 50 to about 90 weight parts of an inorganic filler, about 5 to about 30 weight parts of a hydrophilic binder, about 0.5 to about 20 weight parts of a core-shell structured a cationic latex and about 0.5 to about 20 weight parts of the polyamide-epichlorohydrin resin, based on 100 weight parts of the total solid content of the composition.

The composition may further comprise an additive. Where the composition further comprises an additive, the composition comprises preferably about 50 to about 90 weight parts of an inorganic filler, about 5 to about 30 weight parts of a hydrophilic binder, about 0.5 to about 20 weight parts of a core-shell structured a cationic latex, about 0.5 to about 20 weight parts of a polyamide-epichlorohydrin resin and about 0.015 to about 10 weight parts of an additive, based on 100 weight parts of the total solid content of the composition.

The core-shell structured cationic latex is represented by the following formula (I):
—[A]ₗ—[B]ₘ—[C]ₙ— (I)
in which, A is a polymer unit produced by copolymerization of a copolymerizable monomer containing a tertiary amino group or a quaternary ammonium group, B is a polymer unit produced by copolymerization of a copolymerizable monomer having at least two groups having at least one unsaturated double bond and C is a polymer unit produced by copolymerization of a copolymerizable monomer having a double bond which has not been used for A and B. Further, in formula (I), l is about 10 to about 99 mole %, m is about 0 to about 10 mole % and n is about 0 to about 90 mole %, provided that l+m+n=100 mole %.

Preferably, in an embodiment of the present invention, the core-shell structured cationic latex is an acrylate based cationic latex.

The polyamide-epichlorohydrin resin is a mixture or compound having a polyamide group and epichlorohydrin group.

The inorganic filler includes at least one inorganic substance selected from the group consisting of calcium carbonate, kaolin, talc, calcium sulfate, barium sulfate, titanium oxide, zinc oxide, zinc carbonate, aluminum silicate, silicic acid, sodium silicate, magnesium silicate, calcium silicate, silica and alumina.

Preferably, in an embodiment of the present invention, the inorganic filler is an alumina represented by the following formula (II):
Al₂O₃₋ₚ (OH)₂ₚ.qH₂O (II)
in which p is a natural number of 0 to 3 and q is a rational number of 0 to 10.

Preferably, in an embodiment of the present invention, the hydrophilic binder is a polyvinyl alcohol.

In order to accomplish another object in accordance with an embodiment of the present invention, the recording medium for inkjet printers comprises a substrate and an ink acceptable layer on the substrate, in which the ink acceptable layer comprises an inorganic filler, a hydrophilic binder, and a core-shell cationic latex and a polyamide-epichlorohydrin resin.

The substrate can be any one substance selected from the group consisting of transparent or translucent polyester based films, polycarbonate based films, cellulose-acetate based films and polyethylene based films, polyethylene papers and polypropylene papers with at least one surface coated, one-side coated art papers and both-side coated art papers, cast coated papers, synthetic papers, and resin-coated papers.

Preferably, in an embodiment of the present invention, the substrate has a thickness of about 70 μm to about 350 μm.

Preferably, in an embodiment of the present invention, the ink acceptable layer comprises about 50 to about 90 weight parts of an inorganic filler, about 5 to about 30 weight parts of a hydrophilic binder, about 0.5 to about 20 weight parts of a core-shell structured a cationic latex and about 0.5 to about 20 weight parts of a polyamide-epichlorohydrin resin, based on 100 parts by weight of the total solid content of the composition.

The ink acceptable layer may further comprise an additive. Where the ink acceptable layer further comprises an additive, the ink acceptable layer comprises about 50 to about 90 weight parts of an inorganic filler, about 5 to about 30 weight parts of a hydrophilic binder, about 0.5 to about 20 weight parts of a core-shell structured a cationic latex, about 0.5 to about 20 weight parts of a polyamide-epichlorohydrin resin and about 0.015 to about 10 weight parts of an additive, based on 100 parts by weight of the total solid content of the composition.

The core-shell structured cationic latex is represented by the following formula (I):
—[A]ₗ—[B]ₘ—[C]ₙ— (I)
in which A is a polymer unit produced by copolymerization of a copolymerizable monomer containing a tertiary amino group or a quaternary ammonium group, B is a polymer unit produced by copolymerization of a copolymerizable monomer having at least two unsaturated double bond groups, C is a polymer unit produced by copolymerization of a copolymerizable monomer having a double bond which has not been used for A and B. As noted above, in formula (I), l is about 10 to about 99 mole %, m is about 0 to about 10 mole % and n is about 0 to about 90 mole %, provided that l+m+n=100 mole %.

Preferably, in an embodiment of the present invention, the core-shell structured cationic latex is an acrylate based cationic latex.

The polyamide-epichlorohydrin resin is a mixture or compound having a polyamide group and epichlorohydrin group.

The inorganic filler includes at least one inorganic substance selected from the group consisting of calcium carbonate, kaolin, talc, calcium sulfate, barium sulfate, titanium oxide, zinc oxide, zinc carbonate, aluminum silicate, silicic acid, sodium silicate, magnesium silicate, calcium silicate, silica and alumina.

Preferably, in an embodiment of the present invention, the inorganic filler is an alumina represented by the following formula (II):
Al₂O₃₋ₚ (OH)₂ₚ.qH₂O (II)
in which p is a natural number of 0 to 3 and q is a rational number of 0 to 10.

Preferably, in an embodiment of the present invention, the hydrophilic binder is a polyvinyl alcohol.

Preferably, in an embodiment of the present invention, the ink acceptable layer has a thickness of about 8 μm to about 80 μm.

The recording medium for inkjet printers according to an embodiment of the present invention may further comprise an under coating layer disposed between the substrate and the ink acceptable layer and a protective layer disposed on the ink acceptable layer.

Also, the recording medium for inkjet printers according to an embodiment of the present invention may further comprise a back coating layer disposed at the surface of the substrate on which the ink acceptable layer is not formed.

### BRIEF DESCRIPTION OF THE DRAWING

The above-mentioned objects and features of the present invention will be more apparent by describing the preferred embodiments of the present invention by referring to the appended drawing, in which:

FIG. 1 shows a cross-sectional view of an example recording medium for inkjet printers in accordance with an embodiment of the present invention.

### DETAILED DESCRIPTION OF THE PREFERRED EMBODIMENTS

Hereinbelow, the preferred embodiments of the present invention will be described in greater detail with reference to the accompanying drawings.

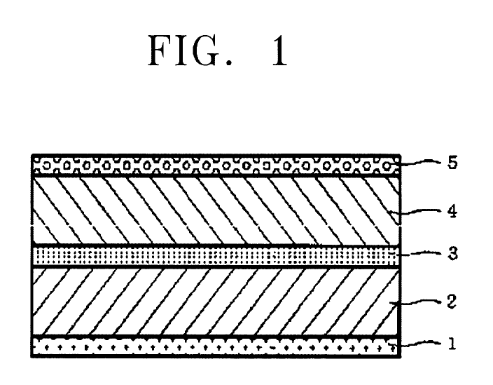

FIG. 1 is a cross-sectional view showing an example of a recording medium for inkjet printers in accordance with an embodiment of the present invention. The recording medium for inkjet printers essentially consists of a substrate 2 and an ink acceptable layer 4. Also, it may further comprise an under coating layer 3 disposed between the ink acceptable layer 4 and the substrate 2, a back coating layer 1 disposed under the substrate, and/or an ink permeable protective layer 5 on the ink acceptable layer 4.

The composition for forming an ink acceptable layer of a recording medium for inkjet printers in accordance with an embodiment of the present invention is prepared by combining an inorganic filler, a hydrophilic binder, a core-shell structured cationic latex and a polyamide-epichlorohydrin resin in a solvent. As used herein, the term “core-shell structured” refers to core-shell polymer particles as known in the art. The core-shell polymer particles have a polymer core and polymer shell where the respective polymers of the core and the shell are selected to provide the desired properties of the polymer particles.

In the composition for forming an ink acceptable layer, the core-shell structured cationic latex can be any substance that has a polymer unit structure containing a cationic group.

Preferred examples of the core-shell structured cationic latex are represented by the following formula (I):
—[A]ₗ—[B]ₘ—[C]ₙ— (I)
in which A is a polymer unit produced by copolymerization of a copolymerizable monomer containing a tertiary amino group or a quaternary ammonium group, B is a polymer unit produced by copolymerization of a copolymerizable monomer having at least two groups with an unsaturated double bond and C is a polymer unit produced by copolymerization of a copolymerizable monomer having a double bond which has not been used for A and B. As noted above, in formula (I), l is about 10 to about 99 mole %, m is about 0 to about 10 mole % and n is about 0 to about 90 mole %, provided that l+m+n=100 mole %.

The core-shell structured cationic latex represented by the formula (I) comprises a unit structure which has a cationic group, a unit structure which acts as a cross-linker in copolymerization and a unit structure which has no ionic properties.

In general, dyes used in color inks for inkjet printers are direct dyes or acidic dyes, and are fixed on a recording medium via a relatively strong ionic bond with a cationic substance such as the latex since they have a carboxylic acid group (—COOH) or a sulfonic acid group (—SO₃H) in their molecules. Thus, an image formed by the dye has an improved water resistance and fixation.

The core-shell structured cationic latex has a structure comprising a core part and a shell part which differ by, for example, the difference in the glass transition temperature (Tg), gel content, molecular weight, and/or cationic functional group content of the respective polymers of the core and the shell. Among these, it is preferable to use a core-shell structured cationic latex with a difference in the cationic functional group content between the core part and the shell part.

The core-shell structured cationic latex with different cationic functional group contents has a core-shell structure comprising a hard core, which does not have a cationic functional group and does not expand, and a soft shell, which has a cationic functional group capable of expansion by an acid. The latex having such a structure has both properties of a filler (i.e. core part) and properties of a binder (i.e. shell part) due to its structural characteristics and thus, can be advantageously used in a composition which uses a filler and binder together.

In general, the cationic latex has a Tg value of about −30° C. to about 60° C. A cationic latex with a low Tg improves the dye fixation, but causes deterioration of the high temperature moisture resistance due to the low Tg value.

Therefore, in the embodiments of the present invention, it is preferable to use a core-shell structured cationic latex having a relatively high Tg value, such as about 50° C. to about 150° C., and particularly from about 60° C. to about 140° C.

In general, a core-shell structured cationic latex with a high Tg value is also advantageous in that it can maintain high porosity in a coating layer.

Preferably, the core-shell structured cationic latex according to an embodiment of the present invention has a particle size of about 20 nm to about 200 nm. The particle size can be achieved by suitably controlling the amount of the additive, such as a surfactant, a radical initiator, and the like, in the preparation of the latex.

In particular, the core-shell structured cationic latex according to an embodiment of the present invention is preferably an acrylate based core-shell structured cationic latex. More preferably, it is a styrene-acryl based core-shell structured cationic latex.

If the content of the core-shell structured cationic latex in the composition for forming an ink acceptable layer is too low, its use has no effect, while if the content is too high, there occurs the same phenomena as in the excessive use of fillers, which may cause formation of cracks in the ink acceptable layer and deterioration in the product suitability for inkjet printing. Considering these, the content of the core-shell structured cationic latex in the composition for forming an ink acceptable layer is preferably about 0.5 to about 20 weight parts, based on 100 weight parts of the total solid content of the composition.

The polyamide-epichlorohydrin resin contained in the composition for forming an ink acceptable layer, along with the core-shell structured cationic latex, can be any simple mixture or chemically bonded compound of a polyamide compound and an epichlorohydrin compound, as long as the resin comprises a polyamide resin with an epichlorohydrin component added thereto.

Also, similar to the polyamide-epichlorohydrin resins, a polyamine-epichlorohydrin resin comprising a polyamine resin and an epichlorohydrin component added thereto can be used along with the core-shell structured cationic latex. The polyamine-epichlorohydrin resin also can be any simple mixture or chemically bonded compound of a polyamine compound and an epichlorohydrin compound, as long as the resin comprises a polyamide resin and an epichlorohydrin component added thereto.

The polyamide-epichlorohydrin resin is well known to those skilled in the art as a paper-strengthening agent. The polyamide-epichlorohydrin resin can be prepared by a known method. A representative preparation method includes dehydration-polycondensation of adipic acid and diethylenetriamine. Also, it is possible to use a commercially available product, which includes FINEX-606, FINEX-414, produced by Taegwang Chemicals Co., Ltd. (Korea), POLYCUP 172, produced by Hercules (USA), and WS525, WS535, and WS570, each produced by PMC (Japan), and the like.

In general, recording media having a porous ink acceptable layer formed of a pigment such as alumina have excellent water resistance. However, when such recording media are dipped in water for a long period of time or exposed to a high temperature and high humidity environment, their water resistance and moisture resistance are deteriorated. According to an embodiment of the present invention, by employing the polyamide-epichlorohydrin resin along with the core-shell structured cationic latex, it is possible to not only improve water resistance, but also improve moisture resistance at high temperature and high humidity.

The polyamide-epichlorohydrin resin acts as a cross-linker, while the cationic component of the polyamide or polyamine acts as a dye fixing agent together with the cationic latex. Therefore, by using the polyamide-epichlorohydrin resin, it is possible to obtain synergy effects. Also, by employing an acidic polyamide-epichlorohydrin resin with the shell part of the core-shell structured cationic latex, which is involved in acid expansion, the shell parts expanded during coating and drying are entangled to improve water resistance of the coating layer. Generally, when the water resistance is excessively increased through the cross-linking achieved by the addition of a cross-linker, the ink absorption is deteriorated or the moisture resistance is weakened in contrast to the improvement of the water resistance. However, the structural entanglement caused by expansion and the entanglement of the shell parts eliminates this disadvantage and does not deteriorate the ink absorption and/or the moisture resistance.

Accordingly, the embodiment of the present invention described below is characterized in that a core-shell structured latex having a high Tg value is used along with a polyamide-epichlorohydrin resin, whereby it is possible to provide a recording medium having excellent long-term water resistance and ink fixation and improved moisture resistance, and whereby the blurring of the printed ink at high temperature and high humidity is reduced.

If the content of the polyamide-epichlorohydrin resin in the composition for forming an ink acceptable layer is too low, its use has no effect, while if the content is too high, the ink absorption is reduced, which may be detrimental to the product's suitability for inkjet printing. Considering these, the content of the polyamide-epichlorohydrin resin is preferably in the range of about 0.5 to about 20 weight parts, based on 100 weight parts of the total solid content of the composition of the ink acceptable layer.

According to the embodiment of the present invention described below, the inorganic filler can be calcium carbonate, kaolin, talc, calcium sulfate, barium sulfate, titanium oxide, zinc oxide, zinc carbonate, aluminum silicate, silicic acid, sodium silicate, magnesium silicate, calcium silicate, silica or alumina. Among these, alumina is preferably used in an embodiment of the present invention. The alumina is represented by the following formula (II):
Al₂O₃₋ₚ (OH)₂ₚ.qH₂O (II)
in which p is a natural number of 0 to 3 and q is a rational number of 0 to 10, particularly 0 to 5. Typically, water (H₂O) in the form of a hydrate represents an aqueous phase capable of evaporating without participating in the formation of crystal lattices. Therefore, in the formula (II), q may not be an integral number. According to an embodiment of the present invention, the alumina preferably has a boehmite structure or an amorphous structure, as analyzed by X ray diffraction.

Since the alumina itself has a positive charge, it can improve fixation of a dye contained in the ink on the ink acceptable layer and produce an image with high print density, excellent color and good transparency. Also, the alumina forms a porous layer and thus, can improve the ink absorption of the ink acceptable layer. Since the resin type, which mainly comprises a binder, uses a predominantly hydrophilic polymer, the ink acceptable layer has weak water resistance. However, in case of the porous layer type provided using alumina as in the embodiment of the present invention described below, the ink acceptable layer mainly comprises a pigment and thus, has excellent water resistance. Also, a porous layer type is advantageous in that it can control surface properties, for example, by eliminating adherence between films which may occur when a binder is used alone.

The alumina of the formula (II) is used as powder or in the form of a sol (e.g. alumina sol) comprising alumina in the form of particles where appropriate. When alumina sol is used, if the particles in the sol are too small, the ink absorption is reduced, while if the particles are too big, transparency of the recording medium can be deteriorated. Normally, a usable alumina has a particle size of about 20 nm to about 200 nm.

When the alumina content in the composition for forming an ink acceptable layer is too low or too high, the adherence between films or the reduction in ink absorption as described above may occur. Therefore, the alumina content is preferably about 50 to about 95 weight parts, based on the 100 weight parts of the total solid content of the composition of the ink acceptable layer.

In addition to the alumina, the ink acceptable layer may further contain a pigment, which includes, for example, inorganic pigments such as calcium carbonate, kaolin, talc, calcium sulfate, barium sulfate, titanium oxide, zinc oxide, zinc carbonate, aluminum silicate, silicic acid, sodium silicate, magnesium silicate, calcium silicate and silica, organic pigments such as plastic pigments and urea resin pigments, or a mixture thereof, as long as the pigment does not damage the effect of the embodiment of the present invention. Such additive pigment is preferably added in an amount of about 20 weight parts, based on the 100 weight parts of the total alumina content.

The hydrophilic binder of the composition for forming an ink acceptable layer is preferably a polyvinyl alcohol. A polyvinyl alcohol is often used as an important binder since it has high ink suitability and is a good adhesive for pigments.

The polyvinyl alcohol used in the embodiment of the present invention preferably has a polymerization degree of about 1000 or more, and more preferably about 1500 to about 5000. A degree of substitution for the polyvinyl alcohol is preferably about 70 to about 100 parts, and more preferably about 80 to about 99.5 parts.

If the polyvinyl alcohol content is too low, the binder cannot perform its function and consequently, the adhesion between the ink acceptable layer containing the polyvinyl alcohol as a binder and the substrate is deteriorated. Also, since other components such as the pigment are increased, surface properties of the ink acceptable layer is deteriorated, for example, forming cracks. If the polyvinyl alcohol content is too high, the ink acceptable layer is substantially composed of the binder alone, whereby the ink absorption and instant dry characteristics may be deteriorated.

Considering these, the binder content in the composition for forming an ink acceptable layer in an embodiment of the present invention is preferably set to about 5 to about 30 weight parts, and particularly about 5 to about 25 weight parts, based on 100 weight parts of the total solid content of the composition of the ink acceptable layer.

The composition for forming an ink acceptable layer according to an embodiment of the present invention may further contain a hydrophilic polymer in addition to the polyvinyl alcohol. Examples of such a hydrophilic polymer include polyvinyl pyrrolidone, methylcellulose, hydroxypropylmethyl cellulose, gelatin, starch, polyethylene oxide, acryl based polymers, polyesters, polyurethanes, and the like. The added amount of the hydrophilic polymer is preferably up to about 50 weight parts, and more preferably about 0 to about 20 weight parts, based on 100 weight parts of the total content of the polyvinyl alcohol.

The solvent of the composition for forming an ink acceptable layer is not limited. However, considering environmental problems and workability, water is usually used. Also, ketones, glycol ethers, alcoholic solvents or methyl cellosolve, ethyl cellosolve, dimethylformamide or dimethylsulfoxide can be used. Specific examples of the ketones include acetone or methylethyl ketone, and specific examples of the glycol ethers include diethylene glycol or mono-butyl ether. Specific examples of alcoholic solvents include methanol, ethanol, butanol or isopropanol.

The content of the solvent is preferably in a range to make the solid content in the composition for forming an ink acceptable layer of about 5 to about 40 weight %. If the solid content is too low, the viscosity is too low, whereby the drying during coating becomes difficult. If the solid content is too high, the viscosity is too high, whereby the coating surface properties may be deteriorated.

Among the solvents, the content of the alcoholic and other organic solvents, except for water, is preferably about 5 weight parts to about 50 weight parts, based on the total solvent content. This is because when the content of the alcoholic solvents and other organic solvents is too low, the drying properties are deteriorated, while when the content is too high, the solubility of the composition can be reduced, causing increase in the price of the final product.

The composition for forming an ink acceptable layer can further contain an additive to complement its properties. A cross-linker can increase water resistance and surface strength by cross-linking a binder component and an inorganic filler component. If the cross-linker content is too low, the cross-linking has no effect, while if its content is too high, the cross-linking degree is excessive, causing reduction in the ink absorption. Considering these, the added cross linker is about 0.015 to about 8 weight parts, based on 100 weight parts of the total solid content of the composition of the ink acceptable layer.

Preferred examples of the cross linker which can be used in the embodiment of the present invention include oxasoline, isocyanate, epoxide, aziridine, melamine-formaldehyde, dialdehyde, boron compounds, zirconium compounds or mixtures thereof. A specific example of the isocyanate is tolylene diisocyanate adduct (TDI adduct), and a specific example of the epoxide is epichlorohydrin. Specific examples of the dialdehyde include glyoxal and glutaric dialdehyde. Specific examples of the boron compounds include boric acid and Borax, and specific examples of the zirconium compounds include zirconyl acetate, zirconyl nitrate and zirconyl chloride. In addition, a fixative agent, a dye, a fluorescent dye, an optical brightness improvement agent, a pH controller, an anti-oxidant, a foam and air entrainment control agent, a leveling agent, a lubricant, a anti-curling agent, a surface controller, a wetting agent, and the like, can be added as additives. The fluorescent dye is used to increase whiteness (i.e. apparent whiteness) which is recognized by naked eyes.

If the total content of the foregoing additives is too low, the effects resulting from the addition of the additives are small, while if it is too high, the printing qualities and coating surface properties of the recording medium can be deteriorated. Considering these, the total content of the foregoing additives in the composition for forming an ink acceptable layer is preferably about 0.015 to about 10 weight parts, based on 100 weight parts of the total solid content of the composition of the ink acceptable layer.

After preparation of the composition for forming an ink acceptable layer, the composition is coated on at least one surface of the substrate, followed by drying to form an ink acceptable layer and thus, a recording medium for inkjet printers is formed. The drying is performed at about 50° C. to about 130° C. If the cross-linker is added, thermal cross-linking reaction by the cross-linker occurs in the drying step. Therefore, if the drying temperature is less than about 50° C., the cross-linking reactivity is deteriorated. Meanwhile, if it exceeds 130° C., an undesired yellowing may occur. Thus, the drying temperature should be adjusted within the foregoing temperature range.

If the ink acceptable layer thus obtained is too thin, it cannot absorb ink, while if it is too thick, the manufacture cost is increased and drying after coating is difficult. Considering these, the ink acceptable layer preferably has a thickness of about 8 μm to about 80 μm.

In the recording medium according to an embodiment of the present invention, the substrate can be any substance selected from the group consisting of transparent or translucent polyester based films, polycarbonate based film, cellulose-acetate based films, polyethylene based film, papers with at least one side coated with polyethylene or polypropylene, one-sided art papers or both-sided art papers, cast coated papers, synthetic papers and resin-coated papers (e.g. baryta paper), but is not limited thereto.

Preferably, in an example of the present invention the substrate has a thickness of about 70 μm to about 350 μm so that it can be readily handled and further prevent bending when a coating layer is formed thereon.

The recording medium according to an embodiment of the present invention as shown in FIG. 1, may selectively comprise an under coating layer 3 between the substrate and ink acceptable layers 2 and 4, respectively, to improve adhesion therebetween. The under coating layer 3 is formed of at least one substance selected from the group consisting of bi-component primer of polyol and polyisocyanate or mono-component primer of acryl, urethane, acryl-urethane and vinyl based compounds. The coated amount of layer 3 is about 0.2 g/m² to about 2 g/m², and the coated thickness of layer 3 is preferably about 0.2 μm to about 2.0 μm, and preferably about 1 μm.

The recording medium according to an embodiment of the present invention may further comprise a protective layer 5 on the ink acceptable layer 4 to protect the ink acceptable layer 4, and a back coating layer 1 under the substrate 2 to protect the substrate 2.

The protective layer 5, which provides excellent surface strength by curing to a degree while showing superior ink permeability, is formed of at least one compound selected from compounds comprising a cellulose, a polyethylene oxide and a cross-linker, and has a thickness of about 0.5 μm to about 3 μm.

In order to improve multi paper feeding and the curling phenomenon, the back coating layer 1 is formed of at least one compound selected from compounds comprising polyvinyl alcohol, polyvinylpyrrolidone, methyl cellulose, hydroxypropylmethyl cellulose, gelatin, polyethylene oxide, acrylic polymers, polyesters and polyurethanes, which are used as a binder in the ink absorption layer, and oxasoline, isocyanate, epoxide, aziridine, melamin-formaldehyde, dialdehyde, boron compounds and zirconium compounds, which are used as a cross-linker. The back coating layer 1 also preferably has a thickness of about 0.5 μm to about 4 μm.

Now, one or more embodiments of the present invention will be described in detail through the following examples. However, the present invention is not limited thereto.

### EXAMPLE 1

A composition for forming an ink acceptable layer having the following composition was prepared in accordance with an embodiment of the present invention.

<Composition for Forming an Ink Acceptable Layer>

| | |
|---|---|
| Alumina | 87.5 weight parts |
| (ALUMINIUMOXID C, produced by | |
| Degussa, Germany) | |
| Polyvinyl alcohol (PVA 224E, produced by | 7.0 weight parts |
| Kuraray, Japan) | |
| Core-shell structured cationic latex | 1.8 weight parts |
| (TruDot DPX-8015087, produced by | |
| Westvaco Corp, USA) | |
| Polyamide-epichlorohydrin | 2.1 weight parts |
| (FINEX-606, produced by Taegwang | |
| Chemicals Co., Ltd., Korea) | |
| Leveling agent (Flow 425, produced by | 1.0 weight parts |
| Tego, Germany) | |
| Fluorescent dye | 0.5 weight parts |
| (SW5274F, produced by Samwon Co., Ltd., Korea) | |
| Boric acid (produced by SAMCHUN PURE | 0.1 weight parts |
| CHEMICAL. Co., Ltd., Korea) | |
| Mixture of distilled water, ethanol and | 400 weight parts |
| dimethylformamide (75:10:15 by weight) | |

The composition for forming an ink acceptable layer described in Example 1 was applied on a gelatin-treated resin-coated paper (e.g. baryta paper) with a basis weight of 200 g/m² using a bar coater and dried at a temperature of 110° C. for 3 minutes.

Thus, a recording medium for inkjet printers having an ink acceptable layer of about 35 μm thickness was prepared.

### EXAMPLE 2

A recording medium for inkjet printers was prepared following the same method as in Example 1, except wherein Example 2, the following composition was used for forming an ink acceptable layer in accordance with an embodiment of the present invention.

<Composition for Forming an Ink Acceptable Layer>

| | |
|---|---|
| Alumina sol (PG 003, produced by Cabot, USA) | 85.0 weight parts |
| Polyvinyl alcohol (PVA 224E, produced by | 10.0 weight parts |
| Kuraray, Japan) | |
| Core-shell structured cationic latex | 1.3 weight parts |
| (TruDot DPX-8015087, produced by | |
| Westvaco Corp, USA) | |
| Polyamide-epichlorohydrin | 1.5 weight parts |
| (FINEX-606, produced by Taegwang | |
| Chemicals Co., Ltd., Korea) | |
| Glyoxal (produced by SAMCHUN | 0.65 weight parts |
| PURE CHEMICAL. Co., Ltd., Korea) | |
| Leveling agent (Flow 425, produced by | 1.0 weight parts |
| Tego, Germany) | |
| Fluorescent dye | 0.5 weight parts |
| (SW5274F, produced by Samwon Co., Ltd., Korea) | |
| Boric acid (produced by SAMCHUN | 0.05 weight parts |
| PURE CHEMICAL. Co., Ltd., Korea) | |
| Mixture of distilled water, ethanol and | 400 weight parts |
| dimethylformamide (70:10:20 by weight) | |

Thus, a recording medium for inkjet printers having an ink acceptable layer of about 35 μm thickness was prepared.

### EXAMPLE 3

A recording medium for inkjet printers was prepared following the same method as in Example 1, except wherein Example 3, the following composition was used for forming an ink acceptable layer in accordance with an embodiment of the present invention. <Composition for Forming an Ink Acceptable Layer>

| | |
|---|---|
| Alumina sol (SS-30, produced by HANA | 76.9 weight parts |
| Chemical Co., Korea) | |
| Alumina | 8.5 weight parts |
| (ALUMINIUMOXID C, produced by | |
| Degussa, Germany) | |
| Polyvinyl alcohol | 8.0 weight parts |
| (PVA P-17, produced by | |
| Oriental Chem. Co., Ltd., Korea) | |
| Core-shell structured cationic latex | 1.5 weight parts |
| (TruDot DPX-8015087, produced by | |
| Westvaco Corp, USA) | |
| Polyamide-epichlorohydrin | 2.5 weight parts |
| (POLYCUP 172, produced by Hercules, USA) | |
| Zirconium oxychloride | 1.0 weight parts |
| (produced by Junsei Chemical Co., Japan) | |
| Leveling agent (Flow 425, produced by | 1.0 weight parts |
| Tego, Germany) | |
| Fluorescent dye | 0.5 weight parts |
| (SW5274F, produced by Samwon Co., Ltd., Korea) | |
| Boric acid (produced by SAMCHUN | 0.1 weight parts |
| Pure Chemical Co., Ltd., Korea) | |
| Mixture of distilled water, ethanol, dimethylformamide | 400 weight parts |
| and dimethylsulfoxide | |
| (70:10:15:5 by weight) | |

Thus, a recording medium for inkjet printers having an ink acceptable layer of about 35 μm thickness was prepared.

### COMPARATIVE EXAMPLE 1

A recording medium for inkjet printers was prepared following the same method as in Example 1, except wherein Comparative Example 1, the following composition was used for forming an ink acceptable layer.

<Composition for Forming an Ink Acceptable Layer>

| | |
|---|---|
| Alumina | 89.0 weight parts |
| (ALUMINIUMOXID C, produced by | |
| Degussa, Germany) | |
| Polyvinyl alcohol (PVA 224E, produced by | 7.3 weight parts |
| Kuraray, Japan) ) | |
| Polyamide-epichlorohydrin | 2.1 weight parts |
| (FINEX-606, produced by Taegwang | |
| Chemicals Co., Ltd., Korea) | |
| Leveling agent (Flow 425, produced by | 1.0 weight parts |
| Tego, Germany) | |
| Fluorescent dye | 0.5 weight parts |
| (SW5274F, produced by Samwon Co., Ltd., Korea) | |
| Boric acid (produced by SAMCHUN | 0.1 weight parts |
| Pure Chemical Co., Ltd., Korea) | |
| Mixture of distilled water, ethanol and | 400 weight parts |
| dimethylformamide (75:10:15 by weight) | |

Thus, a recording medium for inkjet printers having an ink acceptable layer of about 35 μm thickness was prepared.

### COMPARATIVE EXAMPLE 2

A recording medium for inkjet printers was prepared following the same method as in Example 1, except wherein Comparative Example 2, the following composition was used for forming an ink acceptable layer.

<Composition for Forming an Ink Acceptable Layer>

| | |
|---|---|
| Alumina sol (PG 003, produced by | 86.3 weight parts |
| Cabot, USA) | |
| Polyvinyl alcohol (PVA 117, produced by | 10.2 weight parts |
| Kuraray, Japan) | |
| Core-shell structured cationic latex | 1.3 weight parts |
| (TruDot DPX-8087-06, produced by | |
| Westvaco Corp, USA) | |
| Glyoxal (produced by SAMCHUN | 0.65 weight parts |
| Pure Chemical Co., Ltd., Korea) | |
| Leveling agent (Flow 425, produced by | 1.0 weight parts |
| Tego, Germany) | |
| Fluorescent dye | 0.5 weight parts |
| (SW5274F, produced by Samwon Co., Ltd., Korea) | |
| Boric acid (produced by SAMCHUN | 0.05 weight parts |
| Pure Chemical Co., Ltd., Korea ) | |
| Mixture of distilled water, ethanol and | 400 weight parts |
| dimethylformamide (70:10:20 by weight) | |

Thus, a recording medium for inkjet printers having an ink acceptable layer of about 35 μm thickness was prepared.

### COMPARATIVE EXAMPLE 3

A recording medium for inkjet printers was prepared following the same method as in Example 1, except wherein Comparative Example 3, the following composition was used for forming an ink acceptable layer.

<Composition for Forming an Ink Acceptable Layer>

| | |
|---|---|
| Alumina sol (SS-30, produced by HANA | 79.5 weight parts |
| Chemical Co., Korea) | |
| Alumina (ALUMINIUMOXID C, produced by | 8.9 weight parts |
| Degussa, Germany) | |
| Polyvinyl alcohol (PVA 224E, produced by | 8.0 weight parts |
| Kuraray, Japan) | |
| Zirconium oxychloride | 1.0 weight parts |
| (produced by Junsei Chemical Co., Japan) | |
| Leveling agent (Flow 425, produced by | 1.0 weight parts |
| Tego, Germany) | |
| Fluorescent dye | 0.5 weight parts |
| (SW5274F, produced by Samwon Co., Ltd., Korea) | |
| Boric acid (produced by Samchun Com., Korea) | 0.1 weight parts |
| Mixture of distilled water, ethanol, dimethylformamide | 400 weight parts |
| and dimethylsulfoxide (70:10:15:5 by weight) | |

Thus, a recording medium for inkjet printers having an ink acceptable layer of about 35 μm thickness was prepared.

On the inkjet recording media prepared according to the Examples 1, 2 and 3, and Comparative Examples 1, 2 and 3, an image was printed using a color ink-jet printer, specifically a color ink-jet printer Model MJC-1130i, produced by Samsung Electronics Co., Ltd., Korea.

The inkjet recording media according to the Examples 1, 2 and 3, and Comparative Examples 1, 2 and 3, on which the image was printed, were evaluated for their ink absorption, color image sharpness (i.e. bleeding), short-term and long-term water resistance and moisture resistance. Examples of such evaluation methods include the following.

Ink Absorption Test

After a standard image formed mainly of black mixed ink was printed on an A4 size specimen (e.g. MJC-1130i) of the inkjet recording media, a woodfree paper was overlapped and pressed for 10 seconds using a 5 kg iron mass. The ink smeared to the woodfree paper was observed.

As a result, when ink was not smeared to the paper, it was graded “Excellent”, when ink was smeared in a small amount of 5% or less, it was graded “Good”, when ink was smeared in an amount of about 5 to 50%, it was graded “Bad”, and when over 50% ink was smeared, it was graded “Worst.”

Bleeding Test

A standard line formed mainly of composite black mixed ink was printed on an A4 size specimen (e.g. MJC-1130i) of the inkjet recording media, and 24 hours later, the sharpness of the standard line was observed.

As a result, when the standard line was found to have bled 1% or less of the thickness of the standard line, it was graded “Excellent”, when the line was found to have bled 1 to 5%, it was graded “Good”, when the line was found to have bled 5 to 10%, it was graded “Bad”, and when the line was found to have bled over 10%, it was graded “Worst.”

Water Resistance Test

A specimen (e.g. 2.5 cm×5.0 cm) of the inkjet recording media was placed in a water tank at room temperature (25° C.). While stirring the water tank for 30 minutes in case of a short-term test, or for 24 hours in case of a long-term test, the specimen within the tank was observed to detect whether the image was deformed, or if the ink acceptable layer was softened as a result of the test.

As a result of the test, if the optical density change of the standard image was less than 5% and the image was not deformed, it was graded “Excellent”, when the change was between 5 and 10%, it was graded “Good”, when the change was between 10 and 20% or the ink acceptable layer was slightly softened, it was graded “Bad”, and when the change exceeded 20% or the ink acceptable layer was softened, it was graded “Worst.”

Moisture Resistance Test

A standard color image was printed on a A4 size specimen (e.g. MJC-1130i) of the inkjet recording media and stored in a thermohygrostat at a temperature of 60° C. and a relative humidity of 95% for 24 hours. The bleeding of the image was then observed.

As a result, when the image was found to have bled 5% or less of the thickness of the standard image, it was graded “Excellent”, when the image was found to have bled 5 to 10%, it was graded “Good”, when the image was found to have bled 10 to 20%, it was graded “Bad”, and when the image was found to have bled over 20%, it was graded “Worst.”

The inkjet recording media according to Examples 1, 2 and 3, and Comparative Examples 1, 2 and 3, upon which an image had been printed as described above, were subjected to the foregoing tests of ink absorption, sharpness of color image (i.e. bleeding), short-term and long-term water resistance, and moisture resistance and the results are shown in Table 1, wherein “E” represents an Excellent grade, “G” represents a Good grade, “B” represents a Bad grade, and “W” represents a Worst grade.

TABLE 1

| | | | | | Comparative | Comparative | Comparative |
|---|---|---|---|---|---|---|---|
| | | Example 1 | Example 2 | Example 3 | Example 1 | Example 2 | Example 3 |
| Ink absorption | | E | E | E | E | E | E |
| Sharpness (i.e. bleeding) | | E | E | E | E | G | G |
| Water | Short-term | E | E | E | E | G | B |
| resistance | Long-term | E | E | E | B | B | W |

| | | | | | | |
|---|---|---|---|---|---|---|
| Moisture resistance | E | E | E | B | W | W |

As shown in Table 1, the recording media for inkjet printers prepared according to Examples 1, 2 and 3 had excellent water and moisture resistance, and an improved ink absorption amount and ink absorption rate by using the core-shell structured cationic latex and the polyamide-epichlorohydrin resin in the ink acceptable layer in accordance with an embodiment of the present invention.

The recording medium according to Comparative Example 1, which included only a polyamide-epichlorohydrin resin without a core-shell structured cationic latex recording, had excellent water resistance, however Comparative Example 1 had bad moisture resistance at high temperature and high humidity, as well as bad long-term water resistance.

The recording medium according to Comparative Example 2, which did not include a polyamide-epichlorohydrin resin but included only a cationic latex, showed good short-term water resistance but bad long-term water resistance. Particularly, the moisture resistance under high temperature and high humidity was considerably inferior.

The recording medium according to Comparative Example 3, which did not employ a core-shell structured cationic latex nor a polyamide-epichlorohydrin resin, showed bad short-term water resistance, and remarkably low long-term water resistance and moisture resistance under high temperature and high humidity.

As described above, according to the embodiments of the present invention, by employing a core-shell structured cationic latex and a polyamide-epichlorohydrin resin to the ink acceptable layer, it is possible to provide a composition for forming an ink acceptable layer of a recording medium for inkjet printers with remarkably improved short-term and long-term water and moisture resistance under high temperature and high humidity, as well as ink absorption, and a recording medium for inkjet printers using the same.

Although the preferred embodiments of the present invention have been described above, it will be understood by those skilled in the art that the present invention should not be limited to the described preferred embodiments, but various changes and modifications can be made within the spirit and scope of the present invention as defined by the following appended claims.

1. A composition for forming an ink acceptable layer of a recording medium for inkjet printers, said composition comprising:
an inorganic filler;
a hydrophilic binder; and
a core-shell structured cationic latex and a polyamide-epichlorohydrin resin.

2. The composition of claim 1, which comprises, based on 100 weight parts of a total solid content of said composition:
50 to 90 parts by weight of the inorganic filler;
5 to 30 parts by weight of the hydrophilic binder;
0.5 to 20 parts by weight of the core-shell structured cationic latex; and
0.5 to 20 parts by weight of the polyamide-epichlorohydrin resin.

3. The composition of claim 1, which further comprises an additive.

4. The composition of claim 3, which comprises, based on 100 weight parts of a total solid content of said composition:
50 to 90 parts by weight of the inorganic filler;
5 to 30 parts by weight of the hydrophilic binder;
0.5 to 20 parts by weight of the core-shell structured cationic latex;
0.5 to 20 parts by weight of the polyamide-epichlorohydrin resin; and
0.015 to 10 parts by weight of the additive.

5. The composition of claim 1, wherein the core-shell structured cationic latex is represented by the following formula (I):
—[A]ₗ—[B]ₘ—[C]ₙ— (I)
in which
A is a polymer unit produced by copolymerization of a copolymerizable monomer containing a tertiary amino group or a quaternary ammonium group;
B is a polymer unit produced by copolymerization of a copolymerizable monomer having at least two groups having an unsaturated double bond;
C is a polymer unit produced by copolymerization of a copolymerizable monomer having a double bond which has not been used for A and B;
l is 10 to 99 mole %;
m is 0 to 10 mole %; and
n is 0 to 90 mole %, wherein l+m+n=100 mole %.

6. The composition of claim 1, wherein the core-shell structured cationic latex is an acrylate based cationic latex.

7. The composition of claim 1, wherein the polyamide-epichlorohydrin resin is a mixture or compound having a polyamide group and epichlorohydrin group.

8. The composition of claim 1, wherein the inorganic filler includes at least one inorganic substance selected from the group consisting of calcium carbonate, kaolin, talc, calcium sulfate, barium sulfate, titanium oxide, zinc oxide, zinc carbonate, aluminum silicate, silicic acid, sodium silicate, magnesium silicate, calcium silicate, silica and alumina.

9. The composition of claim 1, wherein the inorganic filler is an alumina represented by the following formula (II):
Al₂O₃₋ₚ (OH)₂ₚ.qH₂O (II)
in which
p is a natural number of 0 to 3; and
q is a rational number of 0 to 10.

10. The composition of claim 1, wherein the hydrophilic binder is a polyvinyl alcohol.

11. A recording medium for inkjet printers comprising a substrate and an ink acceptable layer, in which the ink acceptable layer comprises:
an inorganic filler;
a hydrophilic binder; and
a core-shell structured cationic latex and a polyamide-epichlorohydrin resin.

12. The recording medium of claim 11, wherein the substrate is selected from the group consisting of transparent or translucent polyester based films, polycarbonate based films, cellulose-acetate based films and polyethylene based films; polyethylene papers and polypropylene papers with at least one surface coated; one-side coated art papers and two-sides coated art papers; cast coated papers; synthetic papers; and photo papers.

13. The recording medium of claim 11, wherein the substrate has a thickness of 70 μm to 350 μm.

14. The recording medium of claim 11, wherein the ink acceptable layer comprises, based on 100 parts by weight of a total solid content of the ink acceptable layer:
50 to 90 parts by weight of the inorganic filler;
5 to 30 parts by weight of the hydrophilic binder;
0.5 to 20 parts by weight of the core-shell structured cationic latex; and
0.5 to 20 parts by weight of the polyamide-epichlorohydrin resin.

15. The recording medium of claim 11, wherein the ink acceptable layer further comprises an additive.

16. The recording medium of claim 15, wherein the ink acceptable layer comprises, based on 100 parts by weight of a total solid content of the ink acceptable layer:
50 to 90 parts by weight of the inorganic filler;
5 to 30 parts by weight of the hydrophilic binder;
0.5 to 20 parts by weight of the core-shell structured cationic latex;
0.5 to 20 parts by weight of the polyamide-epichlorohydrin resin; and
0.015 to 10 parts by weight of the additive.

17. The recording medium of claim 11, wherein the core-shell structured cationic latex is represented by the following formula (I):
—[A]ₗ—[B]ₘ—[C]ₙ— (I)
in which
A is a polymer unit produced by copolymerization of a copolymerizable monomer containing a tertiary amino group or a quaternary ammonium group;
B is a polymer unit produced by copolymerization of a copolymerizable monomer having at least two groups having an unsaturated double bond;
C is a polymer unit produced by copolymerization of a copolymerizable monomer having a double bond which has not been used for A and B;
l is 10 to 99 mole %;
m is 0 to 10 mole %; and
n is 0 to 90 mole %, wherein l+m+n=100 mole %.

18. The recording medium of claim 11, wherein the core-shell structured cationic latex is an acrylate based cationic latex.

19. The recording medium of claim 11, wherein the polyamide-epichlorohydrin resin is a mixture or compound having a polyamide group and epichlorohydrin group.

20. The recording medium of claim 11, wherein the inorganic filler includes at least one inorganic substance selected from the group consisting of calcium carbonate, kaolin, talc, calcium sulfate, barium sulfate, titanium oxide, zinc oxide, zinc carbonate, aluminum silicate, silicic acid, sodium silicate, magnesium silicate, calcium silicate, silica and alumina.

21. The recording medium of claim 11, wherein the inorganic filler is an alumina represented by the following formula (II):
Al₂O₃₋ₚ (OH)₂ₚ.qH₂O (II)
in which
p is a natural number of 0 to 3; and
q is a rational number of 0 to 10.

22. The recording medium of claim 11, wherein the hydrophilic binder is a polyvinyl alcohol.

23. The recording medium of claim 11, wherein the ink acceptable layer has a thickness of 8 μm to 80 μm.

24. The recording medium of claim 11, which further comprises an under coating layer disposed between the substrate and the ink acceptable layer.

25. The recording medium of claim 11, which further comprises a protective layer disposed on the ink acceptable layer.

26. The recording medium of claim 11, which further comprises a back coating layer disposed on the substrate.

27. The composition of claim 5, wherein the core-shell structured cationic latex is an acrylate based cationic latex.

28. The composition of claim 8, wherein the inorganic filler is an alumina represented by the following formula (II):
Al₂O₃₋ₚ (OH)₂ₚ.qH₂O (II)
in which
p is a natural number of 0 to 3; and
q is a rational number of 0 to 10.

29. The recording medium of claim 17, wherein the core-shell structured cationic latex is an acrylate based cationic latex.

30. The recording medium of claim 20, wherein the inorganic filler is an alumina represented by the following formula (II):
Al₂O₃₋ₚ (OH)₂ₚ.qH₂O (II)
in which
p is a natural number of 0 to 3; and
q is a rational number of 0 to 10.
